(19) United States
(12) Patent Application Publication
(10) Pub. No.: US 2003/0110164 A1
(43) Pub. Date: Jun. 12, 2003

(54) Life of call utility

(75) Inventors: Charles G. Kappell III, Torrance, CA (US); David Morrison, San Jose, CA (US); Tammy K. Ernst, Sunnyvale, CA (US)

Correspondence Address: Siemens Corporation, Attn: Elsa Keller, Legal Administrator, Intellectual Property Department, 186 Wood Avenue South, Iselin, NJ, 08830, US

(73) Assignee: Siemens Information and Communication Networks, Inc.

(21) Appl. No.: 10/014,146

(22) Filed: Nov. 28, 2001

(51) Int. Cl. G06F 7/00

(52) U.S. Cl. 707/3

(57) ABSTRACT

A telecommunications call center includes a controller (301), graphical user interface (302), a database (304), and a query engine (306). The controller (301) stores call information in the database (304), such as call length, duration, party, time, and the like. The graphical user interface (302) subsequently allows a user to enter query fields for a query of the database. The query engine (306) reads the entries, generates a Structured Query Language (SQL) query, and returns results via the graphical user interface.

### BACKGROUND OF THE INVENTION

1. Field of the Invention

The present invention relates to telecommunication systems and, particularly, to a system for accessing information on call-by-call activity of a call center.

2. Description of the Related Art

Telecommunications systems include call centers that maintain databases of call-by-call information. This can include, for example, call duration, time, source, and destination. Such information is used, among other things, for system maintenance, routing, and billing purposes.

Telecommunications systems themselves are becoming increasingly complex. For example, a typical telecommunications system including a call center might include a private branch exchange (PBX) coupling a private telephone network to the public switched telephone network. In addition, the promise of inexpensive voice telephony using the Internet has led to extensive interest in “Voice over IP” (VoIP). In particular, several IP telephony protocols have been developed, including the H.323 Recommendation suite of protocols promulgated by the International Telecommunications Union (ITU), the Session Initiation Protocol (SIP), and Media Gateway Control Protocol (MGCP), to name a few. Such protocols can also be used for “Telephony over LAN” (ToL) applications.

In increasing numbers of systems, IP telephony systems are being implemented alongside existing PBX based systems. In such systems, an IP telephony server may be provided in addition to the PBX, or the PBX may be enhanced with an IP telephony server. In any case, proper system operation requires call center monitoring of both the IP and the PBX-based systems. As can be appreciated, this requires accumulation of a large amount of data into the call center database.

To access the data, typically a user must be able to write a query in Structured Query Language (SQL), or through use of a database professional. Moreover, in typical systems, the result of the SQL query is typically through a report or summary sheet or the like and includes only the information the vendor of the database system wishes to make public. Typically, the user does not have access to all the data in the database and typically cannot easily specify database search criteria.

### SUMMARY OF THE INVENTION

These and other problems in the prior art are overcome in large part by a system and method according to embodiments of the present invention. A telecommunications call center system according to an embodiment of the present invention includes a controller, graphical user interface, a database, and a query engine. The controller stores call information in the database, such as call length, duration, party, time, and the like. The graphical user interface subsequently allows a user to enter query fields for a query of the database. The query engine reads the entries, generates a Structured Query Language (SQL) query, and returns results via the graphical user interface.

A telecommunications system according to an embodiment of the present invention includes a telecommunications switch coupled to the public switched telephone network and one or more private networks, such as packet telephony networks. A call center system couples to the telecommunications switch and monitors call-by-call activity. The call center system includes a controller, graphical user interface, a database that stores information of the call-by-call activity, and a query engine. The graphical user interface is used to enter queries which are translated by the ODBC query engine into queries of the database. The results are then returned via the graphical user interface.

### BRIEF DESCRIPTION OF THE DRAWINGS

A better understanding of the invention is obtained when the following detailed description is considered in conjunction with the following drawings in which:

FIG. 1 is a diagram of a telecommunications system according to an embodiment of the present invention;

FIG. 2 is a block diagram of an exemplary call center according to an embodiment of the present invention;

FIG. 3 is a block diagram illustrating life of call operation according to an embodiment of the present invention;

FIG. 4 is a diagram of an exemplary window for a graphical user interface according to embodiments of the present invention;

FIG. 5 illustrates exemplary control tabs for the window of FIG. 4;

FIG. 6 is a diagram of an exemplary window for a graphical user interface according to embodiments of the present invention;

FIG. 7 is a diagram of another exemplary window for a graphical user interface according to embodiments of the present invention; and

FIG. 8 is a flowchart illustrating operation of an embodiment of the present invention.

### DETAILED DESCRIPTION OF THE INVENTION

Turning now to FIG. 1, a diagram of an exemplary telecommunications system according to an embodiment of the present invention is shown and generally identified by the reference numeral 100. The telecommunications network 100 includes a switch 101 that is coupled to a packet network 102, such as the Internet, a corporate Intranet, or a local area network (LAN); and the public switched telephone network 103. The switch 101 may couple to a plurality of telephony devices 108a-108n (either directly or indirectly via the PSTN 103). A plurality of telephony devices 104a-104n also may be coupled to the packet network 102. The telephony devices may be telephones, wireless telephones, facsimile machines, and the like. The switch 101 communicates with the packet network 102 using any of a variety of packet telephony protocols, such as H.323 or the Session Initiation Protocol (SIP). The switch 101 functions as a private branch exchange (PBX) and a packet telephony server. The switch 101 may be implemented as the HiPath system, available from Siemens Corporation.

A call center system 105 according to an embodiment of the present invention couples to the switch 101. As will be discussed in greater detail below, the call center system 105 functions to store information on call-by-call activity of the system. Further, the call center system 105 implements a graphical user interface and query engine for a user to search and pull records meeting specified criteria.

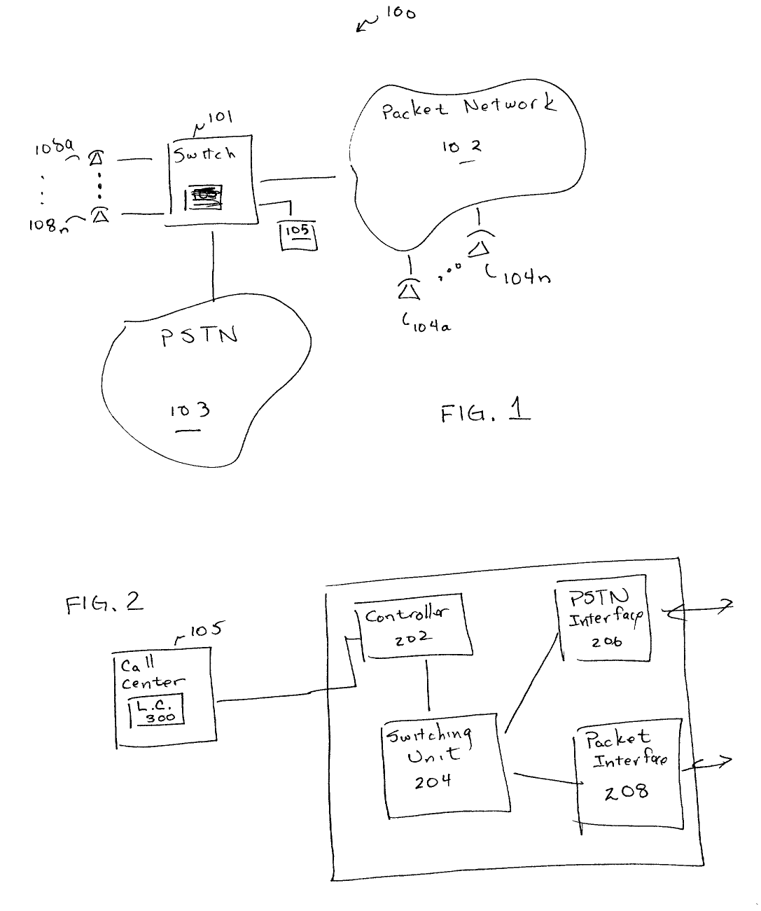

Turning now to FIG. 2, a block diagram of an exemplary call center system according to an embodiment of the present invention is shown. As shown, the system includes a switch 101 and call center 105. The switch 101 includes a controller 202, switching unit 204, PSTN interface 206, and packet network interface 208. The controller 202 supervises operation of the switch 101. The PSTN interface 206 provides a signaling interface to the public switched telephone network. The packet interface 208 provides a similar signaling interface to the packet network. The switching unit 204 provides switching functionality.

The controller 202 couples to call center system 105. The call center system 105 includes a life-of-call utility 300 according to an embodiment of the present invention. As will be explained in greater detail below, the life-of-call utility may include one or more programs running on a workstation or personal computer, such as a Windows-based workstation or personal computer. In operation, the call center system 105 monitors operation of the switch 101 and records data on incoming and outgoing calls. The life-of-call utility 300 provides an interface for accessing database records, as will be explained in greater detail below.

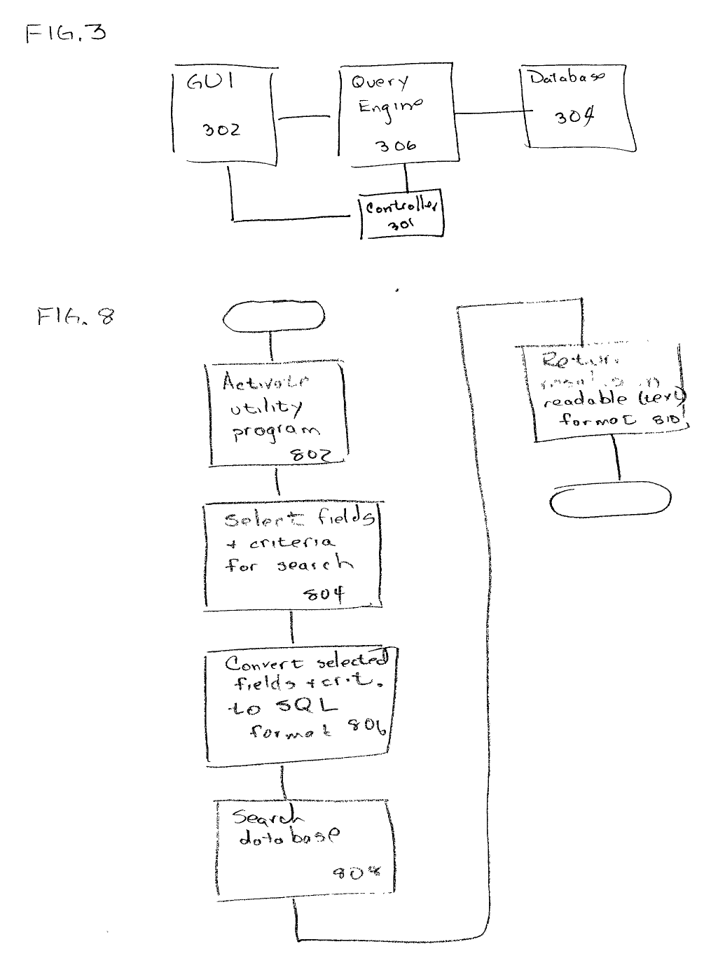

In particular, FIG. 3 is a diagram illustrating a life-of-call utility system. More particularly, as will be discussed in greater detail below, the life-of-call utility system is implemented as one or more computer programs run by a controller 301, such as a microprocessor or microcontroller and implemented to interact with a graphical user interface 302, a database 304, and a query engine 306. The life of call utility system may be implemented on a computer or workstation, such as a Windows-based computer or workstation.

In operation, the database 304 is used to store information concerning all calls made via the switch. The user can then enter a desired query using the GUI 302. The query engine 306 receives the query, converts the query from a GUI-format to a database-readable format, and accesses the database 304 (For example, the call center may include a memory (not shown) storing one or more tables of field aliases and their conversions to SQL syntax.). The controller 301 stores call information in the database, such as call length, duration, party, time, and the like. The graphical user interface 302 subsequently allows a user to enter query fields for a query of the database. The query engine 306 reads the entries, generates a query, such as a Structured Query Language (SQL) query, and returns results via the graphical user interface. The database 304 may be an ODBC compatible database.

Operation of embodiments of the present invention is illustrated with reference to FIGS. 4-7. Shown in FIG. 4 is an exemplary field selection window for performing a database search. In particular, the field selection window 400 is used to select the fields or parameters which are to be searched.

As shown in FIG. 4, the field selection window 400 includes a plurality of selection tabs 401, a Field Not Included (Excluded) list box 402, a Field Included list box 404, and a plurality of command buttons 405 for moving between the list boxes. The list boxes includes lists of (the aliases of) the various fields that may be searched. The Field Included list box 404 may include one or more required fields, as well as the additional fields the user selects. The Fields Not Included list box 402 includes all other database fields that are not to be included in the query results. When items are moved between the two lists, the enabled/disabled state of the command buttons is updated based on the list.

In addition, up and down arrow controls can be used to order items within the lists. In one embodiment, single clicks are used to select items in the list boxes; a double click moves items between the list boxes. Drag and drop may also be supported to move items between the list boxes. In addition, multiple-selection capability may be provided, to allow a user to select and move multiple items.

Finally, a textbox control 406 may be provided to allow the user to enter the maximum number of query result rows that will be displayed. A checkbox control 408 may also be provided to allow the user to specify whether the time/date results are in Greenwich Mean Time.

In addition, as will be explained in greater detail below, the life-of-call utility is implemented using a colDataFields data object and a colEnumerations data object. The colDataFlelds data object is a collection containing one object for each data field available for use in the database query. The colEnumerations object is a collection containing strings representing the possible enumerated values of enumerated data fields. Further, queries are stored in a format of Name, Column, Criteria, and Maximum Number of Rows (MaxRows).

Definitions of exemplary fields are provided in Table 1, below.

TABLE 1

| Field | | Media | |
|---|---|---|---|
| Name | Type | Type | Description |
| Abandon | Numeric | Telephony | The number of seconds that a call |
| Queue | | | spent in the queue before it was |
| Time | | | abandoned |
| Agent End | Value | Telephony | The reason the agent's participa- |
| Cause | | Email | tion in the contact ended: |
| | | | ABANDONED IN IVR QUEUE |
| | | | ABANDONED IN QUEUE |
| | | | ABANDONED WHILE IVR |
| | | | RINGING |
| | | | ABANDONED WHILE RINGING |
| | | | ANSWERED |
| | | | CAMPED ON |
| | | | DISCONNECT ON CONSULT |
| | | | HOLD |
| | | | DISCONNECT ON HOLD |
| | | | DISCONNECT WHILE PARKED |
| | | | DISCONNECTED |
| | | | FORWARD TO AGENT |
| | | | FORWARD TO CALLTYPE |
| | | | FORWARD TO POOL |
| | | | FORWARDED ALWAYS |
| | | | FORWARDED FROM |
| | | | NEGLECT FORWARD |
| | | | NETWORK REACHED |
| | | | PARKED |
| | | | PICKED FROM |
| | | | RECALLED FORWARD |
| | | | REQUEUED |
| | | | RESOLVED |
| | | | SCHEDULE CALLBACK |
| | | | TIMED OUT |
| | | | TRANSFER |
| | | | TRANSFER TO |
| | | | UNMONITORED |
| | | | EXTENSION |
| | | | TRANSFERRED OUT OF SCOPE |
| | | | UNKNOWN |
| Agent | Text | Telephony | The name (First, Middle, Last) of |
| Name | | Email | the agent handling the contact, |
| | | | shown in the format that the name |
| | | | was entered in the system |
| | | | configuration. |
| Answer | Numeric | Telephony | For skills-based routing the call |
| Queue | | (skills- | type number of the contact. For |
| | | based and | Flex-Routing, the ACD group |
| | | Flex- | number of the agent who answered |
| | | Routing) | the call. |
| | | Email | |
| | | (skills- | |
| | | based | |
| | | routing | |
| | | only) | |
| Call End | Value | Telephony | The reason the contact ended: |
| Cause | | Email | ABANDONED IN IVR QUEUE |
| | | | ABANDONED IN QUEUE |
| | | | ABANDONED WHILE IVR |
| | | | RINGING |
| | | | ABANDONED WHILE RINGING |
| | | | ANSWERED |
| | | | CAMPED ON |
| | | | DISCONNECT ON CONSULT |
| | | | HOLD |
| | | | DISCONNECT ON HOLD |
| | | | DISCONNECT WHILE PARKED |
| | | | DISCONNECTED |
| | | | FORWARD TO AGENT |
| | | | FORWARD TO CALL TYPE |
| | | | FORWARD TO POOL |
| | | | FORWARDED ALWAYS |
| | | | FORWARDED FROM |
| | | | NEGLECT FORWARD |
| | | | NETWORK REACHED |
| | | | PARKED |
| | | | PICKED FROM |
| | | | RECALLED FORWARD |
| | | | REQUEUED |
| | | | RESOLVED |
| | | | SCHEDULE CALLBACK |
| | | | TIMED OUT |
| | | | TRANSFER |
| | | | TRANSFER TO |
| | | | UNMONITORED |
| | | | EXTENSION |
| | | | TRANSFERRED OUT OF SCOPE |
| | | | UNKNOWN |
| Call End | Date & | Telephony | Time & date the contact ended. |
| Time | time | Email | |
| Call ID | Text | Telephony | Unique ID of the contact within a |
| | | Email | site |
| Call | Numeric | Telephony | The contact duration in seconds |
| Length | | Email | calculated as the offset from Call |
| | | | Start to when the contact com- |
| | | | pleted or was regueued |
| Call Start | Date & | Telephony | Date and time when the contact |
| | Time | Email | arrived in the call center |
| Call Type | Text | Telephony: | For skills-based routing, the name |
| | | skills- | of the call type associated with |
| | | based and | the contact. For Flex-Routing, the |
| | | Flex-Routing | name of the primary ACD group |
| | | Email: | associated with the call. |
| | | skills- | |
| | | based | |
| | | routing only | |
| Call Type | Numeric | Telephony | The call type step number when |
| Step | | Email | the contact was assigned to an |
| Number | | | agent. |
| | | | For timed-out contacts = 9999 |
| | | | For reserved contacts = 9998 |
| Calling | Numeric | Telephony | The party that made the call: |
| Party | | | External call = −1 |
| | | | All other calls = the extension that |
| | | | originated the call |
| Caption | Text | Telephony | The caption of the contact |
| | | Email | |
| Confer- | Numeric | Telephony | The number of times that the agent |
| ence | | | became part of a conference call |
| Count | | | for this call ID |
| Confer- | Numeric | Telephony | The number of agents involved |
| ence Party | | | when the agent first became part |
| | | | of the conference call |
| Confer- | Numeric | Telephony | The total number of seconds the |
| ence Time | | | agent spent in conference calls. |
| Consult | Numeric | Telephony | The total amount of time in |
| Hold | | Email | seconds that an agent had the call |
| Time | | | on consultation hold (Telephony) |
| | | | or that the email was deferred |
| | | | while the agent was logged on at |
| | | | the site (Email) |
| Depart- | Text | Telephony | Name of the department that the |
| ment | | Email | agent handling the call belongs to |
| Name | | | |
| Destina- | Text | Telephony | Telephony: Original DNIS of the |
| tion | | Email | incoming call |
| | | | Email: email address of the |
| | | | recipient |
| Extension | Numeric | Telephony | Extension number of the agent |
| | | | handling the call |
| First | Numeric | Telephony | The offset in seconds from ring |
| Confer- | | | start when the first conference is |
| ence Start | | | initiated |
| First Hold | Numeric | Telephony | Telephony: the offset in seconds |
| Start | | Email | from ring start when the agent first |
| | | | puts the call on hold. |
| | | | Email: the offset in seconds from |
| | | | ring start to when the agent first |
| | | | defers the email. |
| Handling | Value | Telephony | The initial classification of the |
| Type | | Email | nature of the contact, identifying |
| | | | such things as whether the contact |
| | | | is external or internal: |
| | | | ACD EXTERNAL |
| | | | ACD INTERNAL |
| | | | CALLBACK |
| | | | EMAIL |
| | | | IVR ACD EXTERNAL |
| | | | IVR ACD INTERNAL |
| | | | IVR EXTERNAL |
| | | | IVR INTERNAL |
| | | | RR EXTERNAL |
| | | | RR INTERNAL |
| | | | RR IVR ACD HOLD EXTERNAL |
| | | | RR IVR ACD HOLD INTERNAL |
| | | | RR IVR HOLD EXTERNAL |
| | | | RR IVR HOLD INTERNAL |
| | | | NON-ACD INCOMING |
| | | | NON-ACD INTERNAL |
| | | | NON-ACO OUTGOING |
| | | | UNKNOWN |
| Hold | Numeric | Telephony | The number of times a contact was |
| Count | | Email | put on hold or deferred. |
| Hold Time | Numeric | Telephony | The total number of seconds that |
| | | Email | the contact was on hold or deferred |
| InterSite | Numeric | Telephony | The destination site ID of a net- |
| Destina- | | | worked call |
| tion | | | |
| InterSite | Numeric | Telephony | The originating site ID of a net- |
| Origin | | | worked call |
| InterSite | Value | Telephony | The direction of a networked call: |
| Type | | | INCOMING |
| | | | NONE |
| | | | OUTGOING |
| Inter- | Value | Telephony | Indication of whether the call |
| Switch | | | failed on an inter-switch transfer: |
| Fail | | | YES |
| | | | NO |
| IVR End | Numeric | Telephony | The offset in seconds from call |
| | | | start to when the call leaves the |
| | | | IVR |
| IVR Ex- | Numeric | Telephony | If the call is routed to an IVR, the |
| tension | | | IVR extension or port number used |
| IVR | Numeric | Telephony | The offset in seconds from call |
| Queue | | | start to when the call was queued |
| Start | | | for the IVR |
| IVR Start | Numeric | Telephony | The offset in seconds from call |
| | | | start to when the call was answered |
| | | | by the IVR |
| Priority | Numeric | Telephony | Priority level of the contact at the |
| | | E-mail | time the agent is assigned to |
| | | | handle the contact. |
| | | | Range 0-100 |
| QDNIS | Numeric | Telephony | The DNIS of the call (Same as the |
| | | | Destination unless the call is re- |
| | | | queued. If requeued, then it is the |
| | | | new destination to which the call is |
| | | | requeued.) |
| Queue | Numeric | Telephony | The offset in seconds from call |
| Start | | E-mail | start to when the contact is queued |
| | | | for an agent |
| Queue | Numeric | Telephony | The total amount of time in |
| Time | | E-mail | seconds the contact spent in queue |
| RCG | Numeric | Telephony | The number of the Route Control |
| | | | Group that the call was queued to |
| Reference | Text | Telephony | A call ID that associates this con- |
| Call ID | | Email | tact with another contact |
| Requeue | Numeric | Telephony | Telephony: The number of times a |
| Count | | E-mail | call has passed through any RCG |
| | | | after its initial routing. When a |
| | | | call is first identified as a Contact |
| | | | Center call, the requeue count is 0. |
| | | | It is incremented each time a call |
| | | | passes |
| | | | through an RCG |
| | | | Email: The number of times that |
| | | | the email is forwarded to a dif- |
| | | | ferent agent. When an email is first |
| | | | assigned to an agent, the requeue |
| | | | count is 0. It is incremented each |
| | | | time the email is forwarded to a |
| | | | new agent. For non-contact center |
| | | | calls: −1-255 |
| | | | Range: 1-255 |
| Ring Start | Date & | Telephony | Telephony: the date and time when |
| | Time | E-mail | the agent is first assigned a call and |
| | | | his telephone begins to ring |
| | | | Email: Date and time when the e- |
| | | | mail arrives in the agent's mailbox |
| Segment | Numeric | Telephony | Telephony: offset in seconds from |
| Length | | | Ring Start to when a particular |
| | | | agent leaves the call. |
| | | | Email: offset in seconds from Ring |
| | | | Start to when the agent completes |
| | | | handling the email |
| Sequence | Numeric | Telephony | The order in which the agent |
| Number | | E-mail | entered the contact. It is incre- |
| | | | mented each time the contact is |
| | | | transferred or conferenced. The |
| | | | value is reset to 1 every time the |
| | | | call is requeued |
| Site | Text | Telephony | The name of the site where the |
| | | E-mail | contact occurred |
| Source | Text | Telephony | Telephony: ANI of the incoming |
| | | E-mail | call (may not be available in some |
| | | | areas) |
| | | | Email: the email address of the |
| | | | customer |

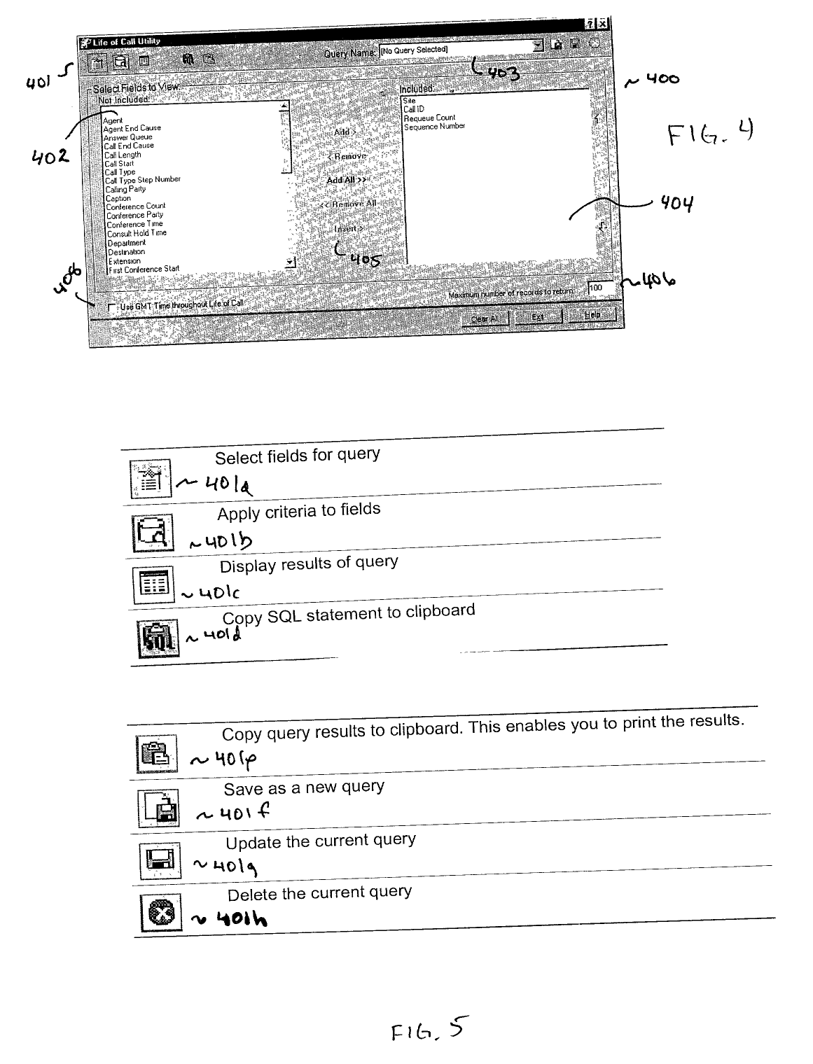

In operation, a user selects the fields to be searched using window 400 and proceeds to criteria and results windows by clicking on control or selection tabs 401. FIG. 5 illustrates exemplary selection tabs 401a-401h. These include a Select fields tab 401a; Apply criteria to fields tab 401b; Display Results tab 401c; Copy SQL statement to clipboard tab 401d; Copy Query Results to Clipboard 401e; Save as New Query 401f; Update Current Query 401g; and Delete Current Query 401.

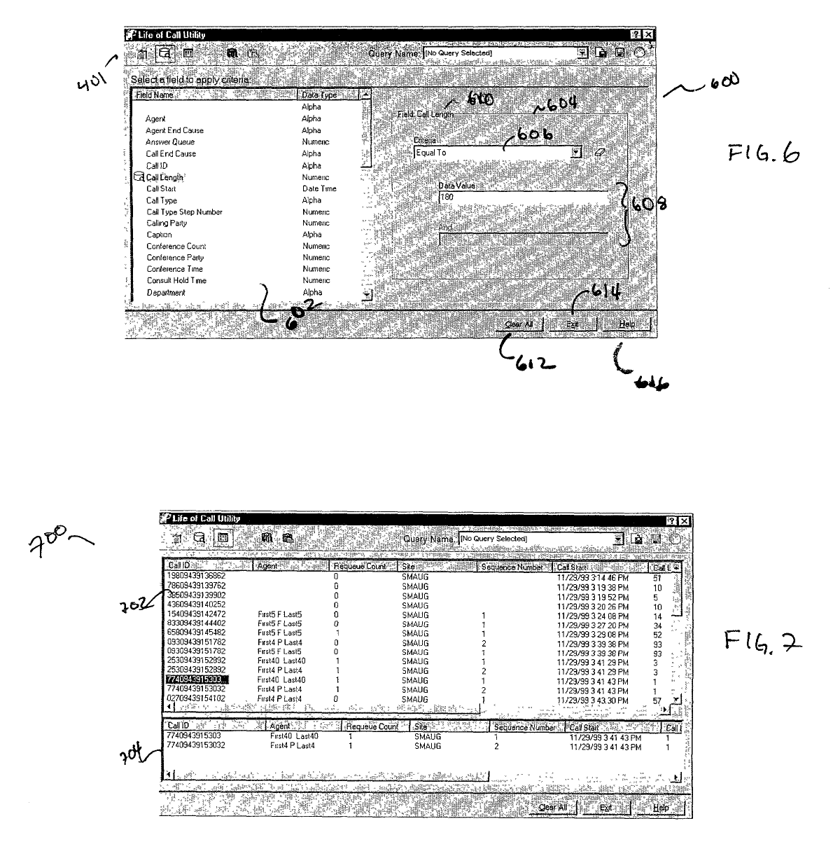

The Select Fields tab 401a allows the user to access the window 400 of FIG. 4, to select the desired fields in the query. The Apply Criteria to Fields tab 401b allows selection of various criteria via the window of FIG. 6, as will be explained in greater detail below. The Display Results tab 401c generates the results window of FIG. 7, as will be explained in greater detail below. The Copy SQL statement to clipboard tab 401d will copy the generated SQL statement to the clipboard. The Copy Query results tab 401e allows the copying of the query results to the clipboard. The Save tab 401f allows the user to save the query. The Update tab 401g allows the user to update or modify the query; and the Delete tab 401h allows the user to delete the query.

FIG. 6 illustrates an exemplary criteria selection window 600. As shown, the criteria selection window 600 includes a field listbox 602 and a set criteria frame 604 for the selected field. The set criteria frame 604 includes a mode drop down 606 and one or more data value boxes 608.

The criteria list 602 displays the fields and their associated data types. Data types include string, numeric, date-time, and enumeration. In one embodiment, the fields are listed in alphabetical order, with the selected fields listed first. The criteria list 602 may also be sortable by clicking on the column headers. That is, clicking on Data Type will sort the list by data type. Clicking Field Name will sort the list alphabetically.

The criteria mode values are settable, for example, using the mode drop down 606 and the value boxes 608. If the criteria type is an enumeration, the mode drop down 606 is used; otherwise the text boxes 608 are used. Mode values include LIKE, EQUAL TO, NOT EQUAL TO, GREATER THAN, LESS THAN, and BETWEEN. Typically, when the mode is BETWEEN, both text boxes will be enabled. Otherwise, only one is enabled.

When the user clicks an item from the field list 602, the frame caption 610 is set to the selected field name. The data object (colDataField) corresponding to the field is retrieved and information in that object is used to set the criteria parameter controls. For enumeration data types, strings identifying the enumerated values are retrieved from the appropriate collection (colEnumeration).

Each time the user changes a criteria comparison mode or a criteria value the corresponding object is updated with the new criteria information. Additionally, the Save Query and Update Query command button states are updated. The Clear All button 612 allows the user to clear all criteria parameters. Another control may be provided which clears the current criteria. Finally, in certain embodiments, none of the criteria are validated until the user selects another of the Life-of-Call screens or tries to save the query. At that point, each object is examined to see if any criteria are set and if so, a validation is performed as shown in Table 2:

TABLE 2

| Data Type | Validation Done |
|---|---|
| String | If mode is “Between” verify that both criteria1 and criteria2 |
| | values are set. |
| Numeric | If mode is “Between” verify that both criteria1 and criteria2 |
| | values are set. |
| | Verify that criteria values are numeric. |
| Date Time | If mode is “Between” verify that both criteria1 and criteria2 |
| | values are set. |
| | Verify that criteria values are dates. |
| Enumeration | None. |

Turning now to FIG. 7, an exemplary query results screen is shown. In the embodiment illustrated, the query results screen includes two ListViews: a list of results 702; and a secondary results window 704 that displays details about a particular result when the user selects a result row in the results window 702. In operation, the user selects the Data Results button 401c after having entered the field and criteria information in the screens of FIGS. 4 and 6.

When the Query Results screen 700 is selected, both ListViews 702, 704 are cleared and then the column headers are built for the top ListView 702. The column headers are the data field names (aliases) in the Field Selection included list 404 (FIG. 4).

Next an SQL query statement is built. The SQL SELECT statement is built from the data field names (aliases) in the Field Selection included list 404. The SQL WHERE clause is built from the objects in the colDataFields collection that have criteria set. Some manipulation may be done to translate enumerated types to the proper numeric value, to handle date/time types that are missing times and to convert date/times to GMT (if needed). When the SQL query statement is complete, it is stored, for example, in a textbox on a fourth (hidden) tab. The SQL statement is not yet ready for execution, though, because it still contains the field names in their alias form. The SQL statement is parsed and the aliases are replaced with the true database field names.

The SQL statement is then executed and the result set is returned in list view 702. As each row (up to the maximum requested) is added to the List View, any enumeration data fields have their field values translated to the associated display strings with the help of the colEnumerations collection. After all rows have been added to the List View, each List View column is resized so that the data within it fits. In both List Views 702, 704, a user can sort the List View by clicking the column header.

When a row in the top List View 702 is selected, the user is requesting more call details for a particular query result. In response, a new query is built that retrieves all call records relating to the selected result. First the system checks that it isn't already displaying information for the selected Call ID in the bottom List View 704. (If so, no more need be done). Column Headers are displayed in the bottom ListView 704 from the data field names (aliases) in the Field Selection included list 404. The new query is built by retrieving the original query from where it was stored. The query is parsed to replace field name aliases with database field names. Then the SQL WHERE clause is stripped off and a new SQL WHERE clause is built. This new WHERE clause allows retrieval of all records related to the selected call, including records that were not returned in the original query.

The SQL statement is executed and the result set is returned. As each row is added to the bottom ListView 704, any enumeration data fields have their field values translated to the associated display strings with the help of the colEnumerations collection.

The user may choose to save a new query, load a saved query, update a saved query or delete a saved query.

When the user clicks the Save Query button 401f (FIG. 5) all the criteria in the colDataFields collection are validated. The user is then prompted for a query name.

Next, a string representing the query “columns” is built from the names (aliases) of all the data fields in the Field Selection included list 404. Another string representing the query “criteria” is built from the information in the colDataFields collection. The query name, columns string, criteria string and the MaxRows value are stored as a record. The new query name is finally added to the drop-down list of saved queries 403 (FIG. 4).

To load an existing query, the user clicks a query name in the saved queries drop-down combo box 403. The procedure starts by clearing out all query field selections and criteria that might have been set and resetting the visible screen to the Field Selection screen.

If the user has selected the “no query selected” item in the drop-down, the query delete button is disabled. If the user selects a saved query name, the query delete button is enabled and the field selection included list 404 is gone through again, with all items forced out of the list (and into the excluded list), even those that are considered mandatory. The information for the saved query is then retrieved. The Columns string is parsed and fields in the string are removed from the excluded list and added to the included list. The Criteria string is parsed and information in that string is stored in the appropriate data field object of the colDataFields collection. Once all the criteria have been stored, the Criteria ListView is sorted and updated. Finally the states (enabled/disabled) of all the command buttons are properly set.

Updating a saved query is very similar to saving a new query. After the criteria are validated, the existing query is deleted. The Columns string and the Criteria string are built and the query information is then stored in the database. Since the query existed previously, the query name does not need to be added to the drop-down combo box 403.

The user clicks the delete query button 401h to delete the currently loaded saved query. A message box prompts the user for confirmation of this action. Once the user responds affirmatively, the query is deleted and the query name is removed from the drop-down combo box. The combo box selection 403 is set to “no query selected”. All query field selections and criteria are cleared and the visible screen is reset to the Field Selection screen. The delete query button is disabled and the states of the other command buttons are properly set.

Two command buttons 401d, 401e may be used to copy information to the clipboard. One copies the SQL statement to the clipboard and the other copies the query results to the clipboard. The SQL copy button 401d is always enabled. The results copy button 401e is only enabled when the Query Results screen is selected.

When the user clicks the SQL copy button 401d, the selected criteria are validated and then the SQL statement is built using the same procedures as when the user selects to view the query results. The statement is originally built with field name aliases and stored on the 4^{th} tab. Then the aliases are replaced with actual database field names and the completed query is copied to the clipboard.

With the results copy button 401e, the results can be copied from either the top ListView 702 or the bottom ListView 704 depending on which one is currently active. For either case, a string buffer is built with first the Column Header names and then the row-by-row data from the ListView. When complete, the string buffer is copied to the clipboard.

Three final buttons that the user can click are the Clear All button 612, the Help button 616 and the Exit button 614.

The Clear All button 612 allows the user to start a new query by resetting the query drop-down combo box to “no query selected”, clearing out all query field selections and criteria and resetting the visible screen to the Field Selection screen. The command button states (enabled/disabled) are adjusted appropriately.

The Help button 616 identifies the proper help topic (id) to display based on the current tab. It then passes this “help id”, along with the help filename to the WinHelp routine.

If there are no unsaved queries, the Exit button 614 simply unloads the form, thus exiting the Life of Call utility. If an unsaved query exists, the user is asked to confirm that they want to close the utility. If the user answers “no” to the confirmation message box, the Life of Call utility remains open, otherwise the form is unloaded and the utility exits.

A flowchart illustrating operation of an embodiment of the present invention is shown in FIG. 8. In step 802, the utility program is activated. The utility program may be embodied as a standalone program, or as a part of another program. In step 804, the fields and criteria to be searched are selected. For example, search parameter field alias names may be displayed as text in the GUI; once the field aliases are selected, the criteria to be searched within the fields are selected. In step 806, the fields and the criteria are converted to a database-readable format such as an SQL format. In step 808, the SQL query is used to search the database, which may be an ODBC database. Finally, in step 810, the results are returned in a GUI-readable format.

The invention described in the above detailed description is not intended to be limited to the specific form set forth herein, but is intended to cover such alternatives, modifications and equivalents as can reasonably be included within the spirit and scope of the appended claims.

What is claimed is:

1. A telecommunications call center, comprising:
a database for storing call information;
a query engine operably coupled to said database; and
a graphical user interface coupled to provide query parameters in a text form; and
wherein said query engine is adapted to translate said query parameters into a database-readable form.

2. A telecommunications call center in accordance with claim 1, said database-readable form comprising a Structured Query Language (SQL) form.

3. A telecommunications call center in accordance with claim 2, wherein results of a query are provided to said graphical user interface in a text-readable form.

4. A method, for use in a telecommunications call center, comprising:
inputting call center database text query information into a graphical user interface;
translating said call center database text query information into a database-readable query; and
returning a result of said database-readable query to said graphical user interface for display.

5. A method in accordance with claim 4, said translating comprising translating into a Structured Query Language (SQL) form.

6. A method in accordance with claim 5, said inputting further comprising:
selecting one or more fields to view from a first graphical user interface window; and
selecting predetermined criteria to apply to said fields using a second graphical user interface window.

7. A telecommunications system comprising:
one or more telecommunications networks;
a switch configured to switch calls between devices on said one or more telecommunications networks; and
a call center adapted to monitor calls through said switch, said call center including
a database for storing call information;
a query engine operably coupled to said database; and
a graphical user interface coupled to provide query parameters in a text form; and
wherein said query engine is adapted to translate said query parameters into a database-readable form.

8. A telecommunications system in accordance with claim 7, said database-readable form comprising a Structured Query Language (SQL) form.

9. A telecommunications system in accordance with claim 8, wherein results of a query are provided to said graphical user interface in a text-readable form.

10. A telecommunications system in accordance with claim 9, said graphical user interface comprising
a first screen for selecting fields for searching;
a second screen for entering search criteria for said fields; and
a third screen for displaying results of said searching.

11. A method, comprising:
providing one or more telecommunications networks;
providing a switch configured to switch calls between devices on said one or more telecommunications networks; and
providing a call center adapted to monitor calls through said switch, said call center including
a database for storing call information;
a query engine operably coupled to said database; and
a graphical user interface coupled to provide query parameters in a text form; and
wherein said query engine is adapted to translate said query parameters into a database-readable form.

12. A method in accordance with claim 11, said database-readable form comprising a Structured Query Language (SQL) form.

13. A method in accordance with claim 12, wherein results of a query are provided to said graphical user interface in a text-readable form.

14. A method in accordance with claim 13, said graphical user interface comprising
a first screen for selecting fields for searching;
a second screen for entering search criteria for said fields; and
a third screen for displaying results of said searching.

15. A telecommunications method for providing a call center, comprising:
providing a database for storing call information;
providing a query engine operably coupled to said database; and
providing a graphical user interface coupled to provide query parameters in a text form; and
wherein said query engine is adapted to translate said query parameters into a database-readable form.

16. A telecommunications method in accordance with claim 15, said database-readable form comprising a Structured Query Language (SQL) form.

17. A telecommunications method in accordance with claim 16, wherein results of a query are provided to said graphical user interface in a text-readable form.
